(19) United States
(12) Patent Application Publication
(10) Pub. No.: US 2009/0115844 A1
(43) Pub. Date: May 7, 2009

(54) UNDERWATER DIGITAL CAMERA

(75) Inventor: CHIH-I CHENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/131,042

(22) Filed: May 31, 2008

(30) Foreign Application Priority Data
Nov. 5, 2007 (CN) 200710202381.1

(51) Int. Cl. H04N 7/18

(52) U.S. Cl. 348/81; 348/E07.085

(57) ABSTRACT

An underwater digital camera includes an image capturing unit, an underwater conditions sensing unit, a memory, and a processor. The image capturing unit is used for capturing images. The underwater condition sensing unit is used for sensing underwater conditions. The processor is used for writing the underwater conditions into the memory together with an image currently captured by image capturing unit while underwater.

### TECHNICAL FIELD

The present invention relates to digital cameras and, particularly, to a underwater digital camera which can capture images underwater and improve safety of divers while they are underwater.

### DESCRIPTION OF RELATED ART

With the development of waterproof technology, underwater digital cameras are widely used by divers for underwater photography. Most underwater digital cameras can only perform the function of capturing images. However, other functions, such as providing water pressure, water temperature, dive time and so on, would be valuable to divers' safety.

What is needed, therefore, is an underwater digital camera that can determine underwater conditions.

### SUMMARY

In accordance with one present embodiment, an underwater digital camera includes an image capturing unit, an underwater conditions sensing unit, a memory, and a processor. The image capturing unit is used for capturing images. The underwater condition sensing unit is used for sensing underwater conditions. The processor is used for writing the underwater conditions into the memory together with an image currently captured by image capturing unit while underwater.

### BRIEF DESCRIPTION OF THE DRAWING

Many aspects of the present underwater digital camera can be better understood with reference to the following drawings. The components in the drawing are not necessarily drawn to scale, the emphasis instead being placed upon clearly illustrating the principles of the present underwater digital camera. Moreover, in the drawings, like reference numerals designate corresponding parts throughout the several views.

FIG. 1 is a schematic, functional block diagram showing the structure of an underwater digital camera according to a present embodiment.

FIG. 2 is a flow chart of a method for capturing an image underwater by an underwater digital camera of FIG. 1.

FIG. 3 is a flow chart of a warning method of an underwater digital camera of FIG. 1.

### DETAILED DESCRIPTION OF THE EMBODIMENTS

Embodiments will now be described in detail below, with reference to the accompanying drawings.

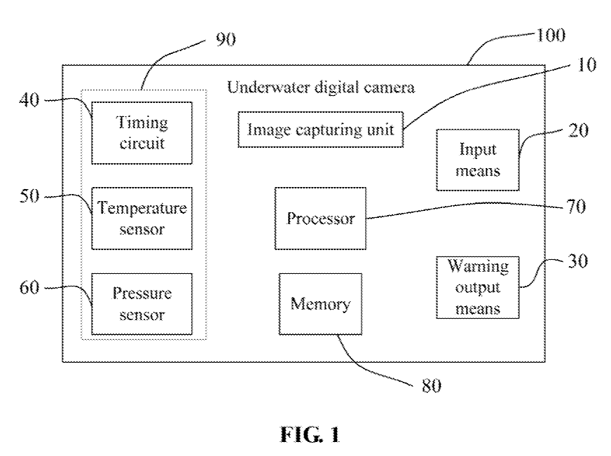

Referring to FIG. 1, an underwater digital camera 100 according to a present embodiment includes an image capturing unit 10, an input means 20, a warning output means 30, a underwater conditions sensing unit 90, a processor 70, and a memory 80. In the present embodiment, the underwater conditions sensing unit 90 includes a timing circuit 40, a temperature sensor 50, and a pressure sensor 60.

The image capturing unit 10 is used for capturing images. The image capturing unit 10 typically includes a lens module (not shown) and an image sensor (not shown) disposed behind the lens module for converting an optical image into an electronic image signal.

The timing circuit 40 is used for clocking dive time, namely the time that a diver has stayed under water.

The pressure sensor 60 is for detecting the water pressure and the diving depth which can be derived from the water pressure. The pressure sensor 60 outputs a pressure signal indicating the surrounding pressure of the digital camera 100. The temperature sensor 50 detects the water temperature and outputs a temperature signal indicating the surrounding water temperature of the digital camera 100.

The processor 70 is electrically connected to the image capturing unit 10, the timing circuit 40, the temperature sensor 50, and the pressure sensor 60, and receives image signals, dive time, pressure signal, and the temperature signal from them respectively. The processor writes the underwater conditions into the memory 80 together with a currently captured image. The underwater conditions and the image can be displayed on a monitor (not shown) of the digital camera 100 as an image in which the underwater conditions is indicated on the image.

The processor 70 can also judge whether the diver currently using the digital camera 100 is in danger by comparing the dive time, the water pressure, and the water temperature with a set of preset values of dive time, water pressure and water temperature respectively. The preset dive time, the preset water pressure, and the preset water temperature can be input by the input means 20, such as operational buttons of the digital camera 100. The processor 70 will send a warning signal to the warning output means 30 if at least one condition of following conditions is satisfied. These conditions are: the dive time longer than the preset dive time; the water pressure greater than the preset water pressure; the water temperature lower than the preset water temperature.

The warning output means 30 is used for outputting a warning signal to the diver to improve the safety of the divers. The warning output means 30 can include a sound generating device, a monitor, or a flash lamp of the digital camera 100 and so on. In the present embodiment, the warning output means 30 includes a flash lamp of the digital camera 100 which can automatically flash when the warning output means 30 receiving a warning signal from the processor 70.

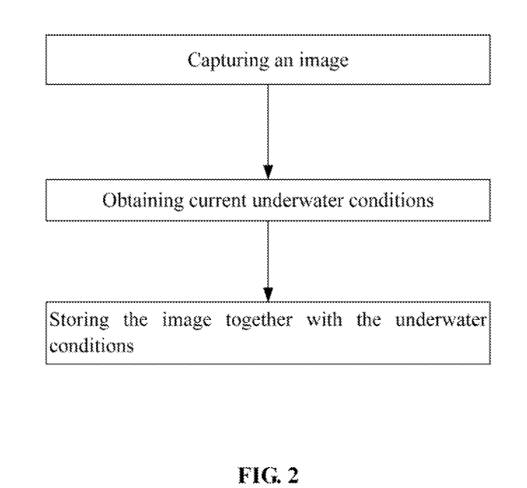

Referring to FIG. 2, a method for capturing an image captured by the underwater digital camera 100 is also provided. The method includes the steps of: capturing an image; obtaining current underwater conditions; storing the image together with the underwater conditions. The underwater conditions include dive time, water pressure, water temperature and so on.

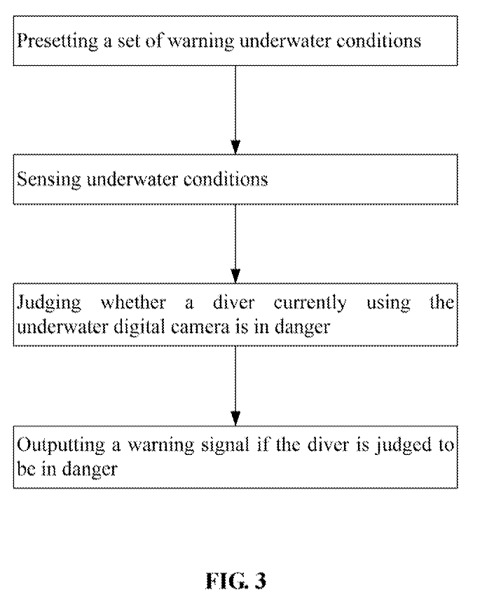

Referring to FIG. 3, a warning method of an underwater digital camera 100 includes the steps of: presetting a set of warning underwater conditions; sensing the underwater conditions; judging whether the diver is in danger by comparing the sensed underwater conditions and the warning underwater conditions; outputting a warning signal if the diver is judged to be in danger. The warning underwater conditions include dive time, water pressure, water temperature and so on.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An underwater digital camera comprising:
an image capturing unit for capturing an image;
an underwater conditions sensing unit for sensing underwater conditions;
a memory; and
a processor for writing the underwater conditions into the memory together with an image currently captured by the image capturing unit while underwater.

2. The underwater digital camera as claimed in claim 1, wherein the underwater digital camera further comprises warning output means capable of outputting warning signal to a diver using the underwater digital camera when instructed by the processor; and wherein the processor is capable of judging whether the diver is in danger according to the underwater conditions.

3. The underwater digital camera as claimed in claim 2, wherein the underwater conditions sensing unit comprises a timing circuit capable of clocking a dive time, a temperature sensor capable of detecting a water temperature, and a pressure sensor capable of detecting a water pressure.

4. The underwater digital camera as claimed in claim 3, wherein a warning signal is generated when at least one of following conditions is satisfied: the dive time longer than a preset dive time; the water pressure bigger than a preset water pressure; the water temperature lower than a preset water temperature.

5. The underwater digital camera as claimed in claim 2, wherein the warning output means is one selected from the group consisting of a flash lamp of the digital camera, a sound generating device and a monitor.

6. The underwater digital camera as claimed in claim 5, wherein the flash lamp is able to automatically flash when the diver being in danger judged by the processor.

7. A method for capturing a image captured by an underwater digital camera, comprising:
capturing an image;
obtaining current underwater conditions; and
storing the image together with the underwater conditions.

8. The method as claimed in claim 7, wherein the underwater conditions comprise dive time, water pressure, and water temperature.

9. A warning method of an underwater digital camera, comprising:
presetting a set of warning underwater conditions;
sensing underwater conditions;
judging whether a diver currently using the underwater digital camera is in danger by comparing the sensed underwater conditions and the warning underwater conditions; and
outputting a warning signal if the diver is judged to be in danger.

10. The method as claimed in claim 9, wherein the set of warning underwater conditions comprise a preset dive time, a preset water pressure, and a preset water temperature, and the underwater conditions comprises dive time, water pressure, and water temperature.

11. The method as claimed in claim 10, wherein a warning signal is generated when at least one condition of following conditions is satisfied: the dive time longer than the preset dive time; the water pressure bigger than the preset water pressure; the water temperature lower than the preset water temperature.
